(19) United States
(12) Patent Application Publication
(10) Pub. No.: US 2020/0052506 A1
(43) Pub. Date: Feb. 13, 2020

(54) ADJUSTABLE STAND FOR CHARGING DEVICE

(71) Applicant: ANDREW BRADFORD GREEN, MT. PLEASANT, SC (US)

(72) Inventor: ANDREW BRADFORD GREEN, MT. PLEASANT, SC (US)

(21) Appl. No.: 16/517,359

(22) Filed: Jul. 19, 2019

Related U.S. Application Data
(60) Provisional application No. 62/700,363, filed on Jul. 19, 2018.

(51) Int. Cl. H02J 7/00; H02J 7/02

(52) U.S. Cl. CPC H02J 7/0027; H02J 7/02; H02J 7/0044; H02J 7/0052

(57) ABSTRACT

A stand for use with a charging device, such as, but not limited to, a Qi Wireless Charger. The stand elevates the charging unit up off a desk or table top, at an angle where a device being charged can be placed thereupon. The invention includes a base, a holder for securely holding the charging device, and a support post or stem connecting the base and platform. The stem may be fixed in height and angle, although alternatively, the height and/or angle may be adjustable.

This application claims priority to U.S. Provisional Application No. 62/700,363, filed Jul. 19, 2019, by Andrew Green, which is incorporated herein in its entirety for all purposes.

### FIELD OF INVENTION

This invention relates to an adjustable stand for use with a recharging device device, including but not limited to the Qi Wireless Charger.

### SUMMARY OF INVENTION

In various exemplary embodiments, the present invention comprises a stand for use with a charging device, such as, but not limited to, a Qi Wireless Charger. The stand elevates the charging unit up off a desk or table top, at an angle where a device being charged can be placed thereupon. In one embodiment shown, the invention comprises a base, a holder for securely holding the charging device, and a support post or stem connecting the base and platform. The stem may be fixed in height and angle, although in additional embodiments, the height and/or angle may be adjustable.

The stem may be integrated with the holder or the base, or both. In one embodiment, the stem is removably attached to the base with screws or other fastening means. The stem may be placed in any location on the base, depending on the material used and the relative centers of gravity.

In several embodiments, the stem is located near the center of the base and bottom of the holder. This allows a computing device to be balanced on top of the base leaning against the charger in the holder. A bump or raised feature may be provided in the top of the base to help hold the bottom of the computing device in place when being charged, although this raised feature may not be necessary if the top of the base is covered with a nonslip material such as, but not limited to, rubber, leather, silicone or other material. In some embodiments, the top cover of the base may provide the raised feature.

In additional embodiments, the bottom of the base may comprise a rubber, plastic, silicone or similar covering in whole or in part, or feet made of the same material or materials.

The charging device cord (e.g., USB cord or power cord) may be routed through a groove or slot in the base and up through a groove or slot in the back of the stem (or, where the stem is hollow, through the stem itself). This enables the charging device to be plugged into a power supply when inserted in the holder.

The holder comprises a shape configured to securely hold the corresponding charging device when inserted in the holder (but allows the charger to be easily removed for travel). In the embodiment shown, for example, the holder is oval in form and configuration to match the shape of a Qi Wireless Charger. The holder may be open in both front and back, as shown, or may be partially or completely enclosed in back. A rubber (or similar material) band or coating may extending wholly or partially around the interior of the holder opening to securely hold the charging device in place.

### BRIEF DESCRIPTION OF THE DRAWINGS

FIG. 1 shows an exploded view of stand in accordance with an embodiment of the present invention.

FIGS. 2-5 shows views of the stand of FIG. 1 in use with a charging device.

FIGS. 6-7 shows perspective views of the stand of FIG. 1 in use with a charging device.

FIG. 8 shows a perspective view of the stand of FIG. 1 with a charging device being installed.

FIG. 9 shows a view of a charging device in travel mode.

FIG. 10 shows a perspective view of the stand of FIG. 1 in use with a cell phone placed in proximity to the charging device.

### DETAILED DESCRIPTION OF EXEMPLARY EMBODIMENTS

In various exemplary embodiments, the present invention comprises a stand for use with a charging device 2, such as, but not limited to, a Qi Wireless Charger. The stand elevates the charging device or unit 2 up off a desk or table top or similar surface, at an angle 50 where a device being charged 6 can be placed thereupon.

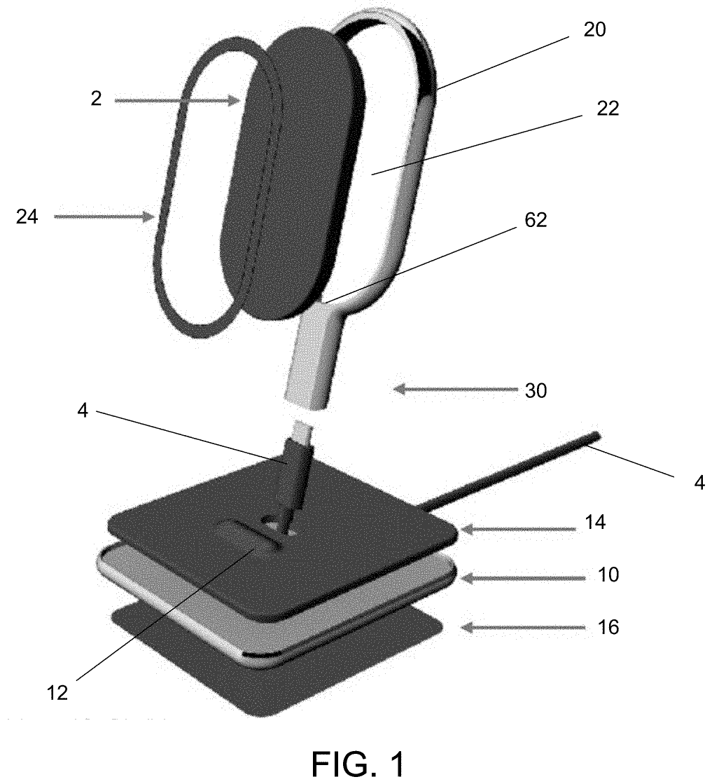

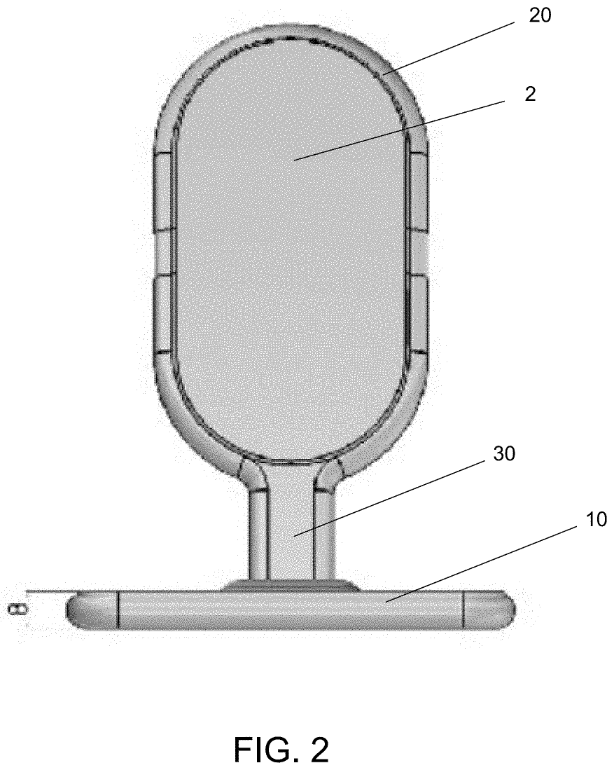

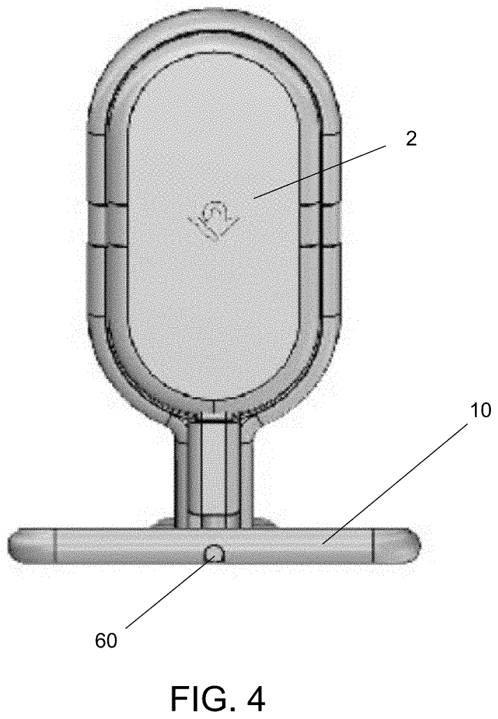

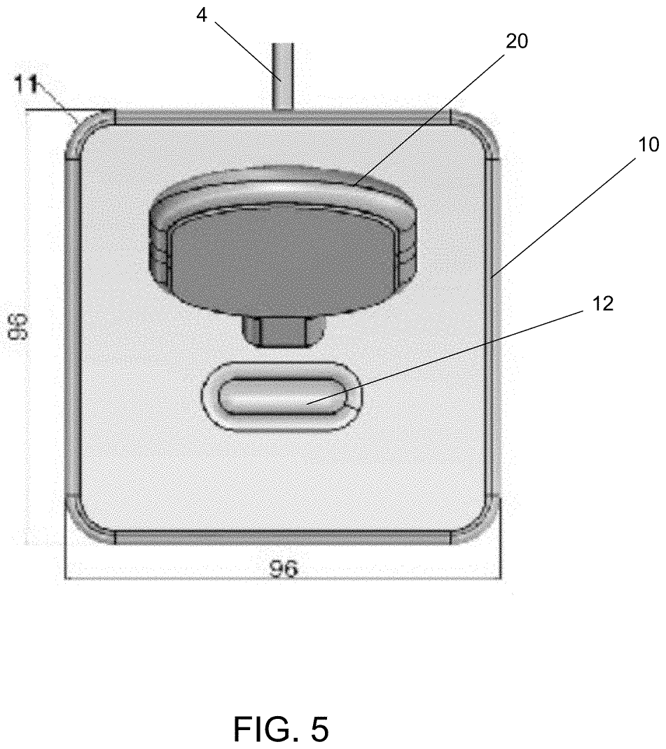

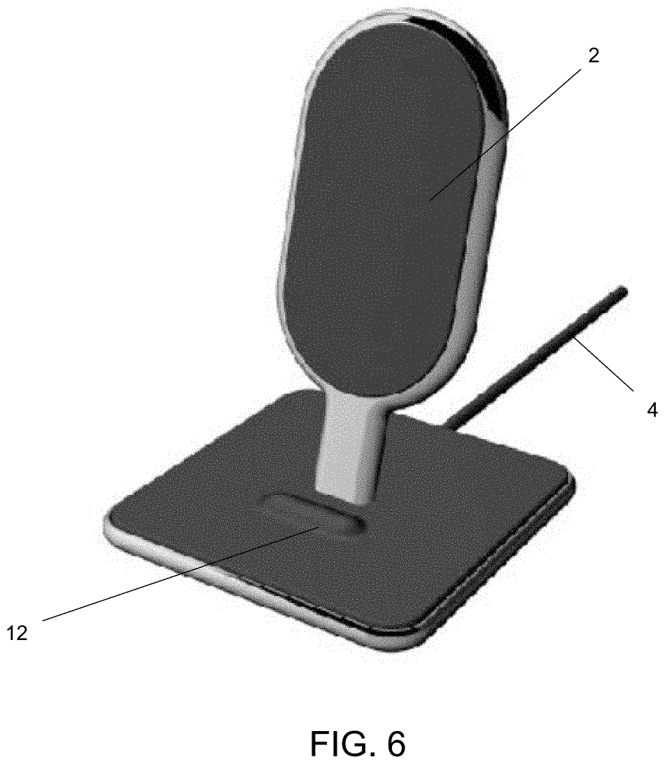

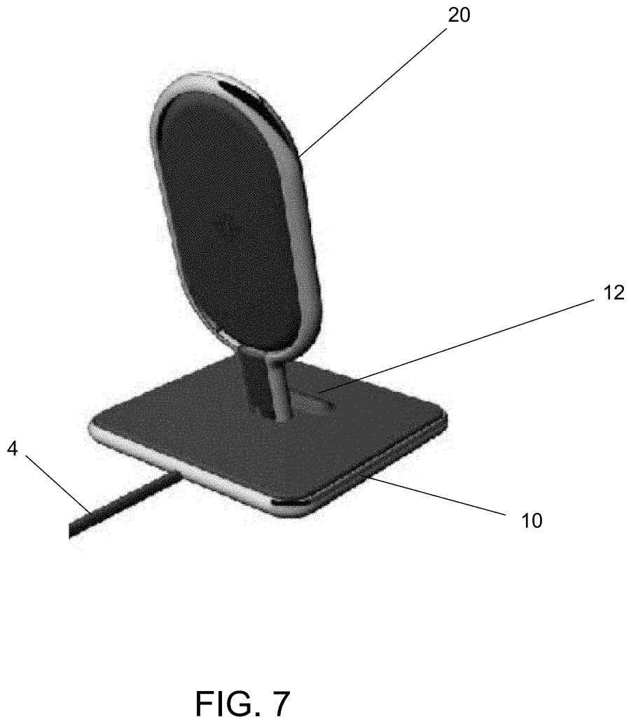

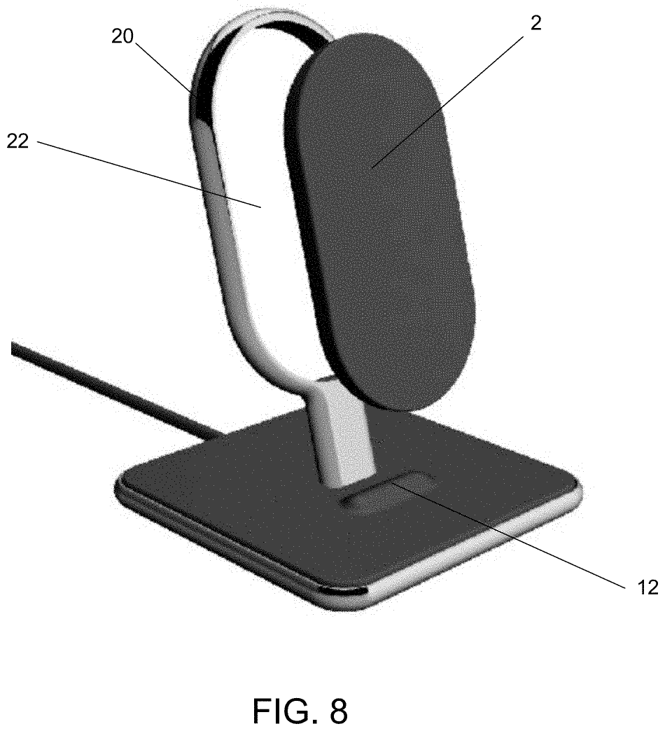

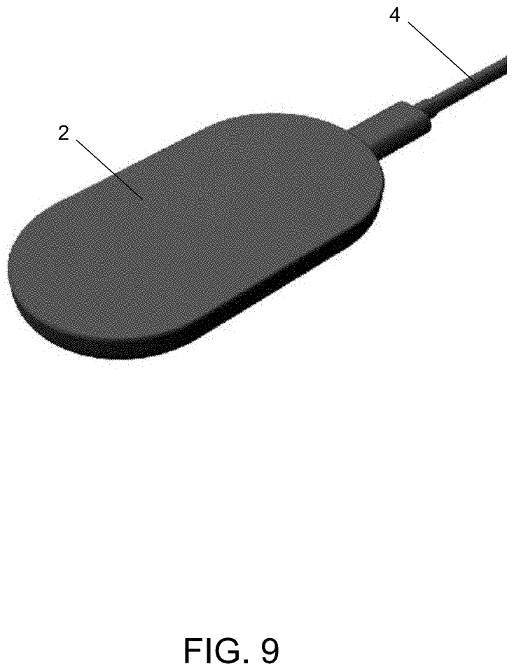

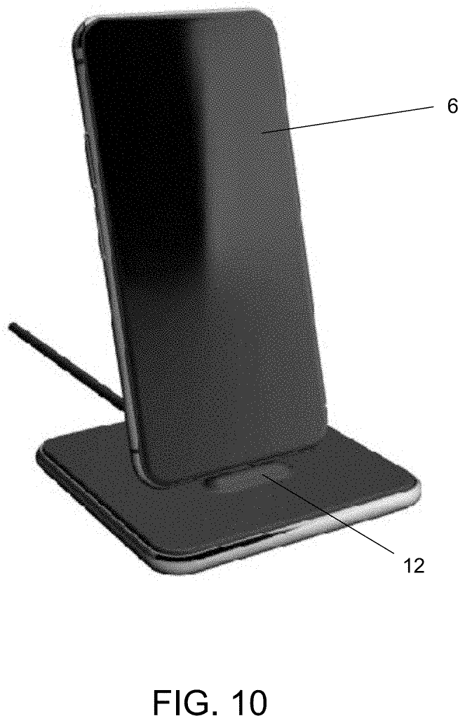

In the embodiment shown in FIGS. 1-10, the invention comprises a base 10, a holder 20 for securely holding the charging device 2, and a support rod, post or stem 30 connecting the base and platform. In one embodiment, the stem 30 is fixed in height and angle. In other embodiments, the height and/or angle of the stem 30 may be adjustable.

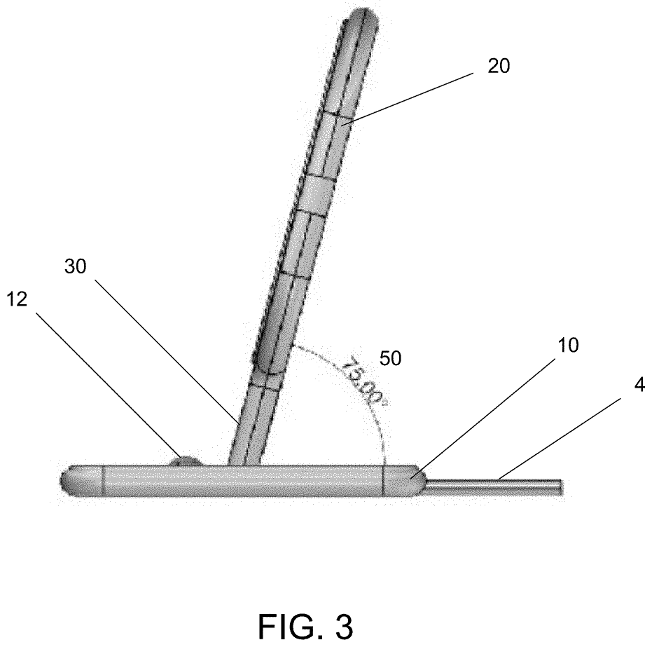

The stem 30 may be integrated, fixedly attached, or a single piece with the holder or the base, or both. In one embodiment, the stem 30 is removably attached to the base 10 with screws or other fastening means. The stem may be placed in any location or position on the base, depending on the material used and the relative centers of gravity. In the exemplary embodiment shown, the stem is located near the center of the base and the bottom of the holder. This allows a computing device or other device to be charged to be balanced on top of the base with a portion of the device to be charged leaning against the charger in the holder in an appropriate position to be charged. The angle 50 between the longitudinal axis or plane of the stem 30 with respect to the longitudinal axis or plane of the base 10 may be between approximately 45 degrees and 85 degrees. As seen in FIG. 3, in one exemplary embodiment the angle 50 between the stem and base is approximately 75 degrees.

A bump or raised feature 12 may be provided in the top of the base to help hold the bottom of the computing device or device to be charged in place when being charged. This raised feature may not be necessary if the top of the base is covered with a nonslip material such as, but not limited to, rubber, leather, silicone or other material. In some embodiments, this top cover 14 of the base may provide the raised feature, regardless of whether the top cover of the base comprises nonslip material.

In additional embodiments, the bottom of the base may comprise a rubber, plastic, silicone or similar foot or bottom covering 16 that covers the bottom of the base in whole or in part, or feet made of the same material or materials.

In several embodiments, the charging device cord 4 (e.g., USB cord or power cord) is routed into an opening and through a groove or slot 60 in the base and up through a groove or slot 62 in the back of the stem (or, where the stem is hollow, through a channel or opening in the stem itself). This enables the charging device 2 to be plugged into a power supply when inserted in the holder.

The holder 20 comprises a shape configured to securely hold the corresponding charging device when inserted in the holder (but allows the charger to be easily removed for travel). In the embodiment shown in FIGS. 1-4, for example, the holder is oval in form to match the shape of a Qi Wireless Charger as the charging device 2. The holder 20 may be open in both front and back, as shown, so that the holder comprises an outer frame with a hole or opening 22 extending therethrough from front to back, or may be partially or completely enclosed on the back. For example, one or more bands or straps of flexible or inflexible material, or combinations thereof, may extend across the back, whereby the user can push the charging device in the spaces or gaps between the bands to help removed the charging device. Alternatively, a section of the back may be covered, with an opening or openings at the top, bottom, or along the sides for use by the user in removing the charging device. As a further embodiment, the back may be wholly covered, with one or more holes for use by the user in removing the charging device. Further, the back material may be wholly or partially flexible, whether wholly or partially covering the back, so that the user may push against the back material in removing the charging device.

A rubber (or similar material) band, lining or coating 70 may extend wholly or partially around the interior of the holder opening to help securely hold the charging device in place. The band, lining or coating may be permanently affixed or removably affixed, so as to allow for changes for color preferences or different sizes or configurations of charging devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A holding stand for a recharging device, comprising:
a base with a top and bottom;
a holder configured to securely hold a recharging device; and
a stem extending from the top of the base to the holder.

2. The holding stand of claim 1, said holder comprising an ovaloid frame with a front face, a back face, and a bottom, wherein the stem extends from the top of the base to the bottom of the holder.

3. The holding stand of claim 2, further comprising a contiguous opening extending through the front face and back face of the holder.

4. The holding stand of claim 3, further comprising a liner extending along the contiguous opening in whole or in part.

5. The holding stand of claim 1, wherein the stem extends upward at a non-right angle from the top of the base.

6. The holding stand of claim 5, wherein the non-right angle is between approximately 45 degrees and approximately 85 degrees.

7. The holding stand of claim 5, wherein the non-right angle is approximately 75 degrees.

8. The holding stand of claim 1, further comprising a bottom cover over some or all of the bottom of the base.

9. The holding stand of claim 1, further comprising a top cover over some or all of the top of the base.

10. The holding stand of claim 1, further comprising a raised ridge or feature on the top of the base proximate the stem.

11. The holding stand of claim 1, further comprising a groove or channel in the base configured to receive a power cable for said recharging device.

12. The holding stand of claim 1, further comprising or groove or channel in the stem configured to receive a power cable for said recharging device.

13. The holding stand of claim 1, wherein the stem is hollow.
